(19) United States
(12) Patent Application Publication
(10) Pub. No.: US 2011/0288258 A1
(43) Pub. Date: Nov. 24, 2011

(54) CROSSLINKED POLYAMIDE

(75) Inventors: PHILIPPE DESBOIS, Edingen-Neckarhausen (DE); Dietrich Scherzer, Neustradt (DE)

(73) Assignee: BASF SE, Ludwigshafen (DE)

(21) Appl. No.: 13/110,207

(22) Filed: May 18, 2011

Related U.S. Application Data
(60) Provisional application No. 61/346,049, filed on May 19, 2010.

(51) Int. Cl. C08G 69/16; C08G 18/80

(52) U.S. Cl. 528/45

(57) ABSTRACT

A process for crosslinking polyamide comprises a diisocyanate or a diacyl halide being reacted with a lactam A at a temperature of from (−30) to 150° C. and next reacting with a lactam B, a catalyst and an activator at a temperature of from 40 to 240° C.

### CROSS-REFERENCE TO RELATED APPLICATION

This application claims the benefit of U.S. Provisional Application Ser. No. 61/346,049 filed May 19, 2010, the entire contents of which are incorporated herein by reference in its entirety.

### FIELD OF THE INVENTION

The present invention relates to a process for crosslinking polyamide.

### BACKGROUND

Crosslinked polyamide is not obtainable via standard polymerization. Since the polymerization processes require long residence times as well as high temperatures, such polymers are much too viscous to be dischargeable and would very quickly clog any plant operated in this way.

The only way to obtain crosslinked polyamides is to use the so-called postcrosslinking procedure whereby an additive is added during polymerization or compounding. After injection molding of the polyamide article, an external stimulus is used to excite this additive by radiation in order that it may react with the polyamide chain to crosslink it for example.

The anionic polymerization of nylon-6 is known and in commercial use. This polymerization is carried out directly in a mold. Since the polymerization is very quick, it can be carried out at a comparatively low temperature (80-200° C.). The use of monomer instead of polymer to fill the mold makes it possible to achieve higher fillage (80-90%). Such polymerization requires the addition of a catalyst (Na, K derivates) and produces linear polyamide chains (thermoplastics).

DE-A-14 20 241 discloses a process for producing linear polyamide chains by addition of KOH as a catalyst and 1,6-bis-(N,N-dibutylureido)hexane as an activator through so-called anionic polymerization of lactams.

Polyamide, Kunststoff Handbuch Vol. ¾, ISBN 3-446-16486-3, 1998, Carl Hanser Verlag, 49-52 discloses the activated anionic polymerization of lactam. It combines the use of sodium caprolactamate as a catalyst with acyllactam derivates to produce linear polyamides.

Macromolecules, Vol. 32, No.23 (1999) page 7726 discloses the activated anionic polymerization of lactam. It combines the use of sodium caprolactamate as catalyst with N,N′-hexamethylene-bis-(2-oxo-1-azepanylcarboxamide) to produce linear polyamides.

The polymer produced turns out linear because it has the inherent disadvantages of thermoplastics compared with thermosets: higher creep, lower resistance to organic solvents.

Charlesby, A., 1953, Nature 171, 167 and Deeley, C. W., Woodward, A. E., Sauer, J. A., 1957, J. Appl. Phys. 28, 1124-1130 disclose irradiation to crosslink injection-molded thermoplastics such as polyamides.

The disadvantage with this method is the postcrosslinking using a radiative apparatus.

### BRIEF SUMMARY

It is an object of the present invention to remedy the aforementioned disadvantages.

We have found that this object is achieved by a novel and improved process for crosslinking polyamide, which comprises a diisocyanate or a diacyl halide being reacted with a lactam A at a temperature of from (−30) to 150° C. and next reacting with a lactam B, a catalyst and an activator at a temperature of from 40 to 240° C.

Alternatively, diisocyanate may be replaced by polyisocyanate and diacyl halide may be replaced by polyacyl halide.

### DETAILED DESCRIPTION OF THE PREFERRED EMBODIMENTS

The process of the present invention can be carried out as follows:

A diisocyanate or diacyl halide is reacted with a lactam A at a temperature of from (−30) to 150° C., preferably from 0 to 80° C., more preferably from 20 to 50° C. and a pressure of from 0.1 to 10 bar, preferably from 0.5 to 5 bar and more preferably atmospheric pressure (standard pressure) in a solvent A. The reaction product maybe with or without further purification, preferably after removal of solvent A in vacuo at from 0.001 to 0.5 bar, preferably from 0.01 to 0.3 bar and more preferably from 0.1 to 0.2 bar and a temperature of from 5 to 200° C., preferably from 10 to 180° C. and more preferably from 20 to 150° C., mixed with a lactam B, a catalyst and an activator and reacted therewith at a temperature of from 40 to 240° C., preferably from 70 to 180° C. and more preferably from 100 to 170° C. and a pressure of from 0.1 to 10 bar, preferably from 0.5 to 5 bar and more preferably atmospheric pressure (standard pressure), more particularly without solvent.

Lactam A may be mixed with a lactam B, a catalyst and an activator at a temperature of from 5 to 200° C., preferably from 10 to 180° C. and more preferably from 20 to 150° C. and a pressure of from 0.1 to 10 bar, preferably from 0.5 to 5 bar and more preferably atmospheric pressure (standard pressure) and reacted therewith at a temperature of from 40 to 240° C., preferably from 70 to 180° C. and more preferably from 100 to 170° C. and a pressure of from 0.1 to 10 bar, preferably from 0.5 to 5 bar and more preferably atmospheric pressure (standard pressure), more particularly without solvent.

Useful diisocyanates include aliphatic diisocyanates such as butylene diisocyanate, hexamethylene diisocyanate, octamethylene diisocyanate, decamethylene diisocyanate, undodecamethylene diisocyanate, dodecamethylene diisocyanate and also aromatic diisocyanate such as tolyl diisocyanate, isophorone diisocyanate, 4,4′-methylenebis(phenyl isocyanate), 4,4′-methylenebis(cyclohexyl isocyanate) or polyisocyanate (Basonat® HI 100 from BASF SE) or their mixtures preferably hexamethylene diisocyanate, tolyl diisocyanate, isophorone diisocyanate or their mixtures, more preferably hexamethylene diisocyanate.

Lactam A may comprise amino-substituted lactam such as aminocaprolactam, aminopiperidone, aminopyrrolidone, aminolauryllactam or their mixtures, preferably aminocaprolactam, aminopyrrolidone or their mixtures and more preferably aminocaprolactam.

Solvent A may comprise dimethyl sulfoxide, methyl chloride, methylene chloride, dioxane, tetrahydrofuran, acetonitrile, tetrahydropyran, N-methylpyrrolidone, N-ethylpyrrolidone, dimethylformamide, caprolactam, lauryllactam, methanol, ethanol, n-propanol, isopropanol or their mixtures, preferably dimethyl sulfoxide, methyl chloride, methylene chloride, tetrahydrofuran or their mixtures and more preferably dimethyl sulfoxide, methylene chloride or their mixtures.

Lactam B may comprise caprolactam, piperidone, pyrrolidone, lauryllactam or their mixtures, preferably caprolactam, lauryllactam or their mixtures and more preferably caprolactam or lauryllactam.

Useful activators include aliphatic diisocyanates such as butylene diisocyanate, hexamethylene diisocyanate, octamethylene diisocyanate, decamethylene diisocyanate, undodecamethylene diisocyanate, dodecamethylene diisocyanate, and also aromatic diisocyanates such as tolyl diisocyanate, isophorone diisocyanate, 4,4′-methylenebis(phenyl isocyanate), 4,4′-methylenebis(cyclohexyl isocyanate) or polyisocyanates such as isocyanurates of hexamethylene diisocyanate, Basonat® HI 100 from BASF SE, allophanates such as ethyl allophanate or their mixtures, preferably hexamethylene diisocyanate, isophorone diisocyanate, and more preferably hexamethylene diisocyanate. Diisocyanates may be replaced by monoisocyanates.

Alternatively, when the activator used is a diacyl halide, useful diacyl halides include aliphatic diacyl halides such as butylenedicarbonyl chloride, butylenedicarbonyl bromide, hexamethylenedicarbonyl chloride, hexamethylenedicarbonyl bromide, octamethylenedicarbonyl chloride, octamethylenedicarbonyl bromide, decamethylenedicarbonyl chloride, decamethylenedicarbonyl bromide, dodecamethylenedicarbonyl chloride, dodecamethylenedicarbonyl bromide and also aromatic diacyl halides such as tolylenedicarbonyl chloride, tolylmethylenedicarbonyl bromide, isophoronedicarbonyl chloride, isophoronedicarbonyl bromide, 4,4′-methylenebis(phenylcarbonyl chloride), 4,4′-methylenebis(phenylcarbonyl bromide), 4,4′-methylenebis(cyclohexane-carbonyl chloride), 4,4′-methylenebis(cyclohexanecarbonyl bromide) or their mixtures, preferably hexamethylenedioyl chloride, hexamethylenedioyl bromide or their mixtures, and more preferably hexamethylenedioyl chloride. Diacyl halides may be replaced by monoacyl halides.

Useful catalysts include sodium caprolactamate, potassium caprolactamate, bromide magnesium caprolactamate, chloride magnesium caprolactamate, magnesium biscaprolactamate, sodium hydrides, sodium metal, sodium hydroxide, sodium methoxide, sodium ethoxide, sodium propoxide, sodium butoxide, potassium hydride, potassium metal, potassium hydroxide, potassium methoxide, potassium ethoxide, potassium propoxide, potassium butoxide, preferably sodium hydrides, sodium metal, sodium caprolactamate and more preferably sodium caprolactamate. (Bruggolen® C 10, a solution of 18% by weight of sodium caprolactamate in caprolactam).

The molar ratio of diacyl halide or diisocyanates to lactam A can be varied within wide limits, is generally in the range from 0.01:1 to 100:1, preferably in the range from 0.1:1 to 10:1 and more preferably in the range from 0.5:1 to 1.5:1.

The molar ratio of solvent A to a diacyl halide or diisocyanate can be varied within wide limits, is generally in the range from 100:1 to 0:1, preferably in the range from 50:1 to 0.5:1 and more preferably in the range from 25:1 to 1:1.

The molar ratio of solvent A to lactam A can be varied within wide limits, is generally in the range from 100:1 to 0:1, preferably in the range from 50:1 to 0.5:1 and more preferably in the range from 10:1 to 1:1.

The molar ratio of lactam B to lactam A can be varied within wide limits, is generally in the range from 1:1 to 10 000:1, preferably in the range from 10:1 to 5000:1 and more preferably in the range from 100:1 to 3000:1.

The molar ratio of lactam B to catalyst can be varied within wide limits, is generally in the range from 1:1 to 10 000:1, preferably in the range from 10:1 to 5000:1 and more preferably in the range from 100:1 to 3000:1.

The molar ratio of lactam A to activator can be varied within wide limits, is generally in the range from 0.01:1 to 100:1, preferably in the range from 0.2:1 to 30:1 and more preferably in the range from 1:1 to 10:1.

The process of the present invention provides crosslinked polyamides for any desired polyamides for example nylon-3, nylon-4, nylon-5, nylon-6, nylon-7, nylon-8, nylon-9, nylon-10, nylon-11, nylon-12, nylon-13, nylon-14, nylon-15, nylon-16, nylon-17 and nylon-18 or copolyamides such as nylon-4/6, nylon-5/6, nylon-4/5, nylon-6/7, nylon-6/8, nylon-6/9, nylon-6/10, nylon-6/12, nylon-4/12, nylon-4/10, nylon-5/10, nylon-5/12, preferably nylon-6, nylon-12, nylon-4/6, nylon-5/6, nylon-4/12, nylon-5/12 and more preferably nylon-6 and nylon-12, more particularly nylon-6.

The crosslinked polyamides produced according to the present invention are useful as material for producing wind turbines, such as rotor blades and cladding of wind turbine towers, automotive parts such as fenders, bumps, shock absorbers, chassis cladding, dashboards, the interior of passenger cells.

### EXAMPLES

### Preparation of Starting Materials

### Example I

Preparation of N,N″-1,6-hexanediyl-bis-[N′-(hexahydro-2-oxo-1H-azepin-3-yl]urea

3.28 g (19.5 mmol) of hexamethylene diisocyanate and 5 g (39 mmol) of α-amino-ε-caprolactam (obtainable as described in example 7 of WO-A-2005/123 669 or in example 1 of WO-A-2007/99029) were stirred in 40 ml of anhydrous dimethyl sulfoxide (DMSO) under nitrogen at 30° C. for 10 h in a round-bottom flask fitted with a stopper, the insoluble product was filtered off and washed 3 times with 20 ml of acetone each time and next dried in vacuo (10 mbar) at room temperature (25° C.) to obtain 7.62 g (17.95 mmol, 92%) of N,N″-1,6-hexanediyl-bis-[N′-(hexahydro-2-oxo-1H-azepin-3-yl]urea (1H NMR in DMSO-d6): 6.20 (HN-COR), 6.40 (ROCNH-R).

### Examples 1 and 2 and Comparative Example A

Synthesis of Nylon-6 by Anionic Polymerization of ε-caprolactam

All polymerization reactions were carried out at 140° C. under stirring in a dry argon atmosphere in a 50 ml glass calorimeter reactor sealed with a greaseless rotaflo stopcock and fitted with a thermocouple and a break-seal glass tube.

### Example 1

2.27 g (20.1 mmol) of ε-caprolactam, 0.3 g (2.34 mmol) of α-amino-ε-caprolactam and 3.13 g (6.36 mmol) of Bruggolen® C20 initiator (80% w/w of blocked diisocyanate in ε-caprolactam) were mixed into the reactor at 140° C. and 1.8 g (2.25 mmol) of Bruggolen® C 10 catalyst (17% w/w of ε-caprolactamate in ε-caprolactam) were introduced into the break-seal glass tube and temperature balanced at 140° C. Once the 140° C. were reached the molten Bruggolen® C20 was injected into the molten mixture by means of a break-seal system and the polymerization allowed to proceed for 20 minutes, and next quenched by cooling the reactor in water (10° C.) to obtain 7.5 g of nylon-6 as a solid material.

1 g of the polymer obtained was poured into 50 ml of hexafluoroisopropanol (HFIP) at room temperature with stirring. After 10 h, a gellike structure was obtained. After filtration, the polymer was recovered on the filter, whereas no polymer was detected in the filtrate after evaporation, indicating that the PA6 was insoluble in HFIP and fully crosslinked. 0.98 g was obtained as a solid material.

Crystallinity was determined by DSC measurement using a Q 2000 from Waters GmbH. Sample weight was 8.5 g and heating and cooling rate was 20 K/min. The sample was measured in accordance with ISO 11357-7. Crystallinity was found to be 29%. A melt enthalpy of 190 J/g for 100% crystalline polyamide was taken as reference.

### Example 2

5 g (44.2 mmol) of ε-caprolactam, 0.3 g (0.71 mmol) of N,N″-1,6-hexanediyl-bis-[N′-(hexahydro-2-oxo-1H-azepin-3-yl]urea and 1.8 g (2.38 mmol) of Bruggolen® C 10 (17% w/w of ε-caprolactamate in ε-caprolactam) were mixed into the reactor at 140° C. and 0.41 g (0.83 mmol) of Bruggolen® C20 (80% w/w of blocked diisocyanate in ε-caprolactam) into the break-seal tube and temperature balanced at 140° C. Once the 140° C. were reached the molten Bruggolen® C20 was injected into the molten mixture by means of a break-seal system and the polymerization allowed to proceed for 20 minutes, and next quenched by cooling the reactor in water (10° C.) to obtain 7.5 g of nylon-6 as a solid material.

1 g of the polymer obtained was poured into 50 ml of hexafluoroisopropanol (HFIP) at room temperature with stirring. After 10 h, a gellike structure was obtained. After filtration, the polymer was recovered on the filter, whereas no polymer was detected in the filtrate after evaporation, indicating that the PA6 was insoluble in HFIP and fully crosslinked. 0.98 g was obtained as a solid material.

Crystallinity was determined by DSC measurement using a Q 2000 from Waters GmbH. Sample weight was 8.5 g and heating and cooling rate was 20 K/min. The sample was measured in accordance with ISO 11357-7. Crystallinity was found to be 19%.

The degree of swelling of the polyamide obtained was 56.

### Example 3

Preparation of 2nd Starting Material

Preparation of N,N″-1,6-hexanediyl-bis-[N′-(hexahydro-2-oxo-1H-azepin-3-yl]diamine (N′,N″-bis(2-oxo-3-azepanyl)hexanediamide)

A 500 ml three-neck flask equipped with a magnetic stirbar is charged with 12.8 g (100 mmol) of α-amino-ε-caprolactam, 14 ml (100 mmol) of triethylamine and 100 ml of freshly distilled dichlormethane (CH2Cl2). Then, a solution of 6.9 ml (47.6 mmol) of adipoyl chloride in 15 ml of CH2Cl2 is added over 30 min via a dropping funnel. The reaction mixture is stirred at room temperature for 16 h. The insoluble product was filtered off. In a 250 mL one-neck flask equipped with a magnetic stirrer and a reflux condenser, the crude substance was washed three times with 50 mL of dichloromethane heated at reflux of the solvent for 2 h to remove triethylammonium chloride and residues of unconverted substances. After filtration, removal of the solvent from the crude substance in vacuo left 16.56 g (45.22 mmol) of N,N″-1,6-hexanediyl-bis-[N′-(hexahydro-2-oxo-1H-azepin-3-yl]diamine. The N,N″-1,6-hexanediyl-bis-[N′-(hexahydro-2-oxo-1H-azepin-3-yl]diamine was recovered from the crude substance by removal of the solvent to constant weight (16.56 g, 45.22 mmol). The final yield of the N,N″-1,6-hexanediyl-bis-[N′-(hexahydro-2-oxo-1H-azepin-3-yl]diamine is 95%.

¹H-NMR (300 MHz, CDCl3): δ ppm=4.44 (m, 2H, —CO(—CH2)CH—NH—CO),

### Example 4

Preparation of Crosslinked Nylon-6 by Anionic Polymerization of ε-caprolactam from N,N″-1,6-hexanediyl-bis-[N′-(hexahydro-2-oxo-1H-azepin-3-yl]diamine

The representative synthetic procedure for the crosslinked nylon-6 comprising 5.3% w/w of N,N″-1,6-hexanediyl-bis-[N′-(hexahydro-2-oxo-1H-azepin-3-yl]diamine (i.e., molar fraction F4)=1.81%) for an initial molar ratio of N,N″-1,6-hexanediyl-bis-[N′-(hexahydro-2-oxo-1H-azepin-3-yl]diamine /C20 of 1.31 is as follows: 5.8 g of ε-caprolactam (51.2 mmol), 0.4 g of N,N″-1,6-hexanediyl-bis-[N′-(hexahydro-2-oxo-1H-azepin-3-yl]diamine (1.092 mmol) and 0.9 g of Bruggolen C10 (1.127 mmol) (17% w/w of ε-caprolactamate in ε-caprolactam) were introduced into the reactor, whereas 0.41 g of Bruggerman C20 (0.832 mmol) (80% w/w of blocked diisocyanate in ε-caprolactam) was introduced into the break-seal glass tube. Once the system was balanced to the temperature of polymerization, the molten C20 was injected into the molten monomer/catalyst/N,N″-1,6-hexanediyl-bis-[N′-(hexahydro-2-oxo-1H-azepin-3-yl]-diamine mixture by means of a break-seal system and the polymerization allowed to stand for 2-5 minutes. The polymerization was quenched by cooling the reactor in water (10° C.).

1 g of the polymer obtained was poured into 50 mL of HFIP at room temperature with stirring. After 10 h, a macrogel structure immersed in the solvent was obtained. After filtration, the polymer was recovered on the filter, whereas no polymer was detected in the filtrate after evaporation, indicating that the PA6 was insoluble in HFIP and fully crosslinked. The degree of swelling of the PA6 samples was found to be equal to 21.

The crosslinked substance obtained in example 4 was demonstrated by DSC measurement through a crystallization starting at 160° C., which is 18° C. below the T_{c} of PA6 synthesized in example 1, a glass transition temperature of 32° C., which is 22° C. below the T_{g} of PA6 synthesized in example 1, a melting point of 193° C., which is 22° C. below the Tₘ of PA6 synthesized in example 1, and also by a reduction in crystallinity from 38% to 18%.

### Example 5

The representative synthetic procedure for the crosslinked nylon-6 comprising 5.3% w/w of N,N″-1,6-hexanediyl-bis-[N′-(hexahydro-2-oxo-1H-azepin-3-yl]diamine (i.e., molar fraction F₍₄₎=1.81%) for an initial molar ratio of N,N″-1,6-hexanediyl-bis-[N′-(hexahydro-2-oxo-1H-azepin-3-yl]diamine /C20 of 2.77 is as follows: 6 g of ε-caprolactam (50.8 mmol), 0.4 g of N,N″-1,6-hexanediyl-bis-[N′-(hexahydro-2-oxo-1H-azepin-3-yl]diamine and 0.9 g of Bruggolen C10 (1.127 mmol) (17% w/w of ε-caprolactamate in ε-caprolactam) were introduced into the reactor, whereas 0.2 g of Bruggerman C20 (0.406 mmol) (80% w/w of blocked diisocyanate in ε-caprolactam) was introduced into the break-seal glass tube. Once the system was balanced to the temperature of polymerization, the molten C20 was injected into the molten monomer/catalyst/(4) mixture by means of a break-seal system and the polymerization allowed to stand for 2-5 minutes. The polymerization was quenched by cooling the reactor in water (10° C.).

1 g of the polymer obtained was poured into 50 mL of HFIP at room temperature with stirring. After 10 h, a macrogel structure immersed in the solvent was obtained. After filtration, the polymer was recovered on the filter, whereas no polymer was detected in the filtrate after evaporation, indicating that the PA6 was insoluble in HFIP and fully crosslinked.

### Example 6

The representative synthetic procedure for the crosslinked nylon-6 comprising 2.7% w/w of N,N″-1,6-hexanediyl-bis-[N′-(hexahydro-2-oxo-1H-azepin-3-yl]diamine (i.e., molar fraction F₍₄₎=0.88%) for an initial molar ratio of N,N″-1,6-hexanediyl-bis-[N′-(hexahydro-2-oxo-1H-azepin-3-yl]diamine /C20 of 2.24 is as follows: 7 g of ε-caprolactam (61.9 mmol), 0.2 g of N,N″-1,6-hexanediyl-bis-[N′-(hexahydro-2-oxo-1H-azepin-3-yl]diamine (0.546 mmol) and 0.17 g of Bruggolen C10 (0.2128 mmol) (17% w/w of ε-caprolactamate in ε-caprolactam) were introduced into the reactor, whereas 0.12 g of Bruggerman C20 (0.24 mmol) (80% w/w of blocked diisocyanate in ε-caprolactam) was introduced into the break-seal glass tube. Once the system was balanced to the temperature of polymerization, the molten C20 was injected into the molten monomer/catalyst/(4) mixture by means of a break-seal system and the polymerization allowed to stand for at least 30 minutes. The polymerization was quenched by cooling the reactor in water (10° C.).

1 g of the polymer obtained was poured into 50 mL of HFIP at room temperature with stirring. After 10 h, a macrogel structure immersed in the solvent was obtained. After filtration, the polymer was recovered on the filter, whereas no polymer was detected in the filtrate after evaporation, indicating that the PA6 was insoluble in HFIP and fully crosslinked. The degree of swelling of the PA6 samples was found to be equal to 32.

The DSC measurement of the crosslinked PA6 showed a crystallization starting at 160° C., which is 18° C. below the T_{c} of PA6 synthesized in example 1, a glass transition temperature of 32° C., which is 22° C. below the T_{g} of PA6 synthesized in example 1, a melting point of 193° C., which is 22° C. below the Tₘ of PA6 synthesized in example 1, and also a reduction in crystallinity from 38% to 18%. No reduction of the T_{g} was observed in comparison with the crosslinked PA6 obtained in example 4.

### Example 7

The representative synthetic procedure for the crosslinked nylon-6 comprising 2.7% w/w of N,N″-1,6-hexanediyl-bis-[N′-(hexahydro-2-oxo-1H-azepin-3-yl]diamine (i.e., molar fraction F₍₄₎=0.88%) for an initial molar ratio of N,N″-1,6-hexanediyl-bis-[N′-(hexahydro-2-oxo-1H-azepin-3-yl]diamine /C20 of 0.66 is as follows: 6 g of ε-caprolactam (50.97 mmol), 0.2 g of N,N″-1,6-hexanediyl-bis-[N′-(hexahydro-2-oxo-1H-azepin-3-yl]diamine (0.546 mmol) and 0.9 g of Bruggolen C10 (1.1267 mmol) (17% w/w of ε-caprolactamate in ε-caprolactam) were introduced into the reactor, whereas 0.41 g of Bruggolen C20 (0.832 mmol) (80% w/w of blocked diisocyanate in ε-caprolactam) was introduced into the break-seal glass tube. Once the system was balanced to the temperature of polymerization, the molten C20 was injected into the molten monomer/catalyst/(4) mixture by means of a break-seal system and the polymerization allowed to stand for at least 30 minutes. The polymerization was quenched by cooling the reactor in water (10° C.).

1 g of the polymer obtained was poured into 50 mL of HFIP at room temperature with stirring. Although a homogeneous solution was obtained at room temperature, a microscopic gel structure appears, indicating that the PA6 is less crosslinked.

### Example 8

The representative synthetic procedure for the crosslinked nylon-6 comprising 1% w/w of N,N″-1,6-hexanediyl-bis-[N′-(hexahydro-2-oxo-1H-azepin-3-yl]diamine (i.e., molar fraction F₍₄₎=0.326%) for a molar ratio of N,N″-1,6-hexanediyl-bis-[N′-(hexahydro-2-oxo-1H-azepin-3-yl]diamine /C20 of 0.25 is as follows: 6.13 g of ε-caprolactam (54.2 mmol), 0.075 g of N,N″-1,6-hexanediyl-bis-[N′-(hexahydro-2-oxo-1H-azepin-3-yl]diamine (0.205 mmol) and 0.9 g of Bruggolen C10 (1.127 mmol) (17% w/w of ε-caprolactamate in ε-caprolactam) were introduced into the reactor, whereas 0.41 g of Bruggolen C20 (0.832 mmol) (80% w/w of blocked diisocyanate in ε-caprolactam) was introduced into the break-seal glass tube. Once the system was balanced to the temperature of polymerization, the molten C20 was injected into the molten monomer/catalyst/(4) mixture by means of a break-seal system and the polymerization allowed to stand for at least 30 minutes. The polymerization was quenched by cooling the reactor in water (10° C.).

1 g of the polymer obtained was poured into 50 mL of HFIP at room temperature with stirring. A homogeneous solution was obtained at room temperature without a macroscopic phase separation, indicating that the PA6 is less crosslinked.

### Example 9

The representative synthetic procedure for the crosslinked nylon-6 comprising 1% w/w of N,N″-1,6-hexanediyl-bis-[N′-(hexahydro-2-oxo-1H-azepin-3-yl]diamine (i.e., molar fraction F₍₄₎=0.326%) for a molar ratio of N,N″-1,6-hexanediyl-bis-[N′-(hexahydro-2-oxo-1H-azepin-3-yl]diamine /C20 of 0.84 is as follows: 6.4 g of ε-caprolactam (56.6 mmol), 0.075 g of N,N″-1,6-hexanediyl-bis-[N′-(hexahydro-2-oxo-1H-azepin-3-yl]diamine (0.205 mmol) and 0.9 g of Bruggolen C10 (1.127 mmol) (17% w/w of ε-caprolactamate in ε-caprolactam) were introduced into the reactor, whereas 0.12 g of Bruggolen C20 (0.244 mmol) (80% w/w of blocked diisocyanate in ε-caprolactam) was introduced into the break-seal glass tube. Once the system was balanced to the temperature of polymerization, the molten C20 was injected into the molten monomer/catalyst/N,N″-1,6-hexanediyl-bis-[N′-(hexahydro-2-oxo-1H-azepin-3-yl]diamine mixture by means of a break-seal system and the polymerization allowed to stand for at least 30 minutes. The polymerization was quenched by cooling the reactor in water (10° C.).

1 g of the polymer obtained was poured into 50 mL of HFIP at room temperature with stirring. A homogeneous solution was obtained at room temperature without a macroscopic phase separation, indicating that the PA6 is less crosslinked.

### Example 10

The representative synthetic procedure for the crosslinked nylon-6 comprising 1% w/w of N,N″-1,6-hexanediyl-bis-[N′-(hexahydro-2-oxo-1H-azepin-3-yl]diamine (i.e., molar fraction F₍4)=0.326%) for a molar ratio of N,N″-1,6-hexanediyl-bis-[N′-(hexahydro-2-oxo-1H-azepin-3-yl]diamine /C20 of 2.02 is as follows: 6.48 g of ε-caprolactam (57.3 mmol), 0.075 g of N,N″-1,6-hexanediyl-bis-[N′-(hexahydro-2-oxo-1H-azepin-3-yl]diamine (0.205 mmol) and 0.9 g of Bruggolen C10 (1.127 mmol) (17% w/w of ε-caprolactamate in ε-caprolactam) were introduced into the reactor, whereas 0.05 g of Bruggolen C20 (0.101 mmol) (80% w/w of blocked diisocyanate in ε-caprolactam) was introduced into the break-seal glass tube. Once the system was balanced to the temperature of polymerization, the molten C20 was injected into the molten monomer/catalyst/N,N″-1,6-hexanediyl-bis-[N′-(hexahydro-2-oxo-1H-azepin-3-yl]diamine mixture by means of a break-seal system and the polymerization allowed to stand for at least 30 minutes. The polymerization was quenched by cooling the reactor in water (10° C.).

1 g of the polymer obtained was poured into 50 mL of HFIP at room temperature with stirring. After 10 h, a macrogel structure immersed in the solvent was obtained. After filtration, the polymer was recovered on the filter, whereas no polymer was detected in the filtrate after evaporation, indicating that the PA6 was insoluble in HFIP and fully crosslinked. The degree of swelling of the PA6 samples was found to be equal to 39.

### Example 11

The representative synthetic procedure for the crosslinked nylon-6 comprising 0.5% w/w of N,N″-1,6-hexanediyl-bis-[N′-(hexahydro-2-oxo-1H-azepin-3-yl]diamine (i.e., molar fraction F₍₄₎=0.164%) for a molar ratio of N,N″-1,6-hexanediyl-bis-[N′-(hexahydro-2-oxo-1H-azepin-3-yl]diamine /C20 of 1.02 is as follows: 6.51 g of ε-caprolactam (57.5 mmol), 0.038 g of N,N″-1,6-hexanediyl-bis-[N′-(hexahydro-2-oxo-1H-azepin-3-yl]diamine (0.1037 mmol) and 0.9 g of Bruggolen C10 (1.127 mmol) (17% w/w of ε-caprolactamate in ε-caprolactam) were introduced into the reactor, whereas 0.05 g of Bruggolen C20 (0.101 mmol) (80% w/w of blocked diisocyanate in ε-caprolactam) was introduced into the break-seal glass tube. Once the system was balanced to the temperature of polymerization, the molten C20 was injected into the molten monomer/catalyst/N,N″-1,6-hexanediyl-bis-[N′-(hexahydro-2-oxo-1H-azepin-3-yl]diamine mixture by means of a break-seal system and the polymerization allowed to stand for at least 30 minutes. The polymerization was quenched by cooling the reactor in water (10° C.).

1 g of the polymer obtained was poured into 50 mL of HFIP at room temperature with stirring. A homogeneous solution was obtained at room temperature without a macroscopic phase separation, indicating that the PA6 is less crosslinked.

### Example 12

The representative synthetic procedure for the crosslinked nylon-6 comprising 0.2% w/w of N,N″-1,6-hexanediyl-bis-[N′-(hexahydro-2-oxo-1H-azepin-3-yl]diamine (i.e., molar fraction F₍₄₎=0.066%) for a molar ratio of N,N″-1,6-hexanediyl-bis-[N′-(hexahydro-2-oxo-1 H-azepin-3-yl]diamine /C20 of 0.81 is as follows: 6.53 g of ε-caprolactam (57.7 mmol), 0.0153 g of N,N″-1,6-hexanediyl-bis-[N′-(hexahydro-2-oxo-1H-azepin-3-yl]diamine (0.0417 mmol) and 0.9 g of Bruggolen C10 (1.127 mmol) (17% w/w of ε-caprolactamate in ε-caprolactam) were introduced into the reactor, whereas 0.02 g of Bruggolen C20 (0.051 mmol) (80% w/w of blocked diisocyanate in ε-caprolactam) was introduced into the break-seal glass tube. Once the system was balanced to the temperature of polymerization, the molten C20 was injected into the molten monomer/catalyst/N,N″-1,6-hexanediyl-bis-[N′-(hexahydro-2-oxo-1H-azepin-3-yl]diamine mixture by means of a break-seal system and the polymerization allowed to stand for at least 30 minutes. The polymerization was quenched by cooling the reactor in water (10° C.).

1 g of the polymer obtained was poured into 50 mL of HFIP at room temperature with stirring. A homogeneous solution was obtained at room temperature without a macroscopic phase separation, indicating that the PA6 is less crosslinked.

Synthesis of nylon-6 by anionic polymerization of ε-caprolactam

All polymerizations were carried out in bulk at 140° C. under stirring in a dry argon atmosphere in a 50 mL glass calorimeter reactor sealed with a greaseless rotaflo stopcock and fitted with a thermocouple and a break-seal glass tube.

Synthesis of Linear Nylon-6. (Example A)

The representative synthetic procedure for the anionic polymerization of ε-caprolactam is as follows: 6.2 g of ε-caprolactam (54.8 mmol) and 0.89 g of Bruggolen C 10 (1.188 mmol) (Bruggemann Chemical, 17% w/w of sodium ε-caprolactamate in caprolactam) were introduced into the reactor, whereas 0.41 g of Bruggolen C20 (0.832 mmol) (Bruggemann Chemical, 80% w/w of blocked diisocyanate in ε-caprolactam) was introduced into the break-seal glass tube. Once the system was balanced to the temperature of polymerization, the molten C20 was injected into the molten catalyst/monomer mixture, through the break-seal, and the polymerization allowed to proceed for 20 minutes. The polymerization was quenched by cooling the reactor in water (10° C.) to obtain 7.4 g of nylon-6 (100% of the starting materials added).

1 g of the polymer obtained was poured into 50 mL of hexafluoroisopropanol (HFIP) at room temperature with stirring. After 5 minutes the solution became transparent and homogeneous. After filtration, the polymer was fully recovered from the filtrate by removal of the solvent to constant weight, indicating that the linear PA6 was fully soluble in HFIP.

Synthesis of Linear Nylon-6. (Example B)

The representative synthetic procedure for the anionic polymerization of ε-caprolactam is as follows: 7.1 g of ε-caprolactam (62.7 mmol) and 0.3 g of Bruggolen C 10 (0.40 mmol) (Bruggemann Chemical, 17% w/w of sodium ε-caprolactamate in caprolactam), corresponding to 0.6% mol/mol caprolactam, were introduced into the reactor, whereas 0.1 g of Bruggolen C20 (0.24 mmol) (Bruggemann Chemical, 80% w/w of blocked diisocyanate in ε-caprolactam), corresponding to 0.3% mol/mol caprolactam, was introduced into the break-seal glass tube. Once the system was balanced to the temperature of polymerization, the molten C20 was injected into the molten catalyst/monomer mixture, through the break-seal, and the polymerization allowed to proceed for 20 minutes. The polymerization was quenched by cooling the reactor in water (10° C.) to obtain 7.5 g of nylon-6 (100% of the starting materials added).

1 g of the polymer obtained was poured into 50 mL of hexafluoroisopropanol (HFIP) at room temperature with stirring. After 5 minutes the solution became transparent and homogeneous. After filtration, the polymer was fully recovered from the filtrate by removal of the solvent to constant weight, indicating that the linear PA6 was fully soluble in HFIP.

Synthesis of Linear Nylon-6. (Example C)

See Macromolecules, Volume 32, No. 23 (1999), 7726: Ex. PCL 9, p. 7727

Comparative example B was repeated with polymerization at 155° C.; the resulting polymer was still soluble.

Swelling Test of Crosslinked PA6

The state of swelling of the crosslinked PA6 was characterized by the equilibrium degree of swelling Q. Q is defined as the quotient of the (swollen) final volume V_{f} in HFIP and the (collapsed) initial volume Vᵢ and may equally be given, according to equation 1, as the quotient of the weight fractions of the network in the initial and final gels, and mᵢ and m_{f}, respectively, where _{ρHFIP} (=1.452 g/mL) and _{ρPA6} (1.14 g/mL) are the density of the solvent and of the linear PA6 obtained by anionic polymerization, respectively.

▪(Q=V₁f/V₁i=1+(m₁f/m₁i−1)((_{⊥}PA6/(_{⊥}HFIP)& eq. (1)

We claim:

1. A process for crosslinking polyamide, which comprises a diisocyanate or a diacyl halide being reacted with a lactam A at a temperature of from (−30) to 150° C. and next reacting with a lactam B, a catalyst and an activator at a temperature of from 40 to 240° C.

2. The process for crosslinking polyamide according to claim 1 wherein a diisocyanate or a diacyl halide is reacted with a lactam A at a temperature of from 0 to 80° C. and next reacted with a lactam B, a catalyst and an activator at a temperature of from 70 to 180° C.

3. The process for crosslinking polyamide according to claim 1 wherein a diisocyanate or a diacyl halide is reacted with a lactam A at a temperature of from 20 to 50° C. and next reacted with a lactam B, a catalyst and an activator at a temperature of from 100 to 170° C.

4. The process for crosslinking polyamide according to claim 1 wherein a diisocyanate or a diacyl halide is reacted with a lactam A at a temperature of from 0 to 80° C.

5. The process for crosslinking polyamide according to claim 1 wherein the molar ratio of diisocyanate or diacyl halide to lactam A is in the range from 0.01:1 to 100:1.

6. The process for crosslinking polyamide according to claim 1 wherein the molar ratio of diisocyanate or diacyl halide to lactam A is in the range from 0.1:1 to 10:1.

7. The process for crosslinking polyamide according to claim 1 wherein the molar ratio of lactam B to lactam A is in the range from 1:1 to 10 000:1.

8. The process for crosslinking polyamide according to claim 1 wherein the molar ratio of lactam B to lactam A is in the range from 10:1 to 5000:1.

9. The process for crosslinking polyamide according to claim 1 wherein the molar ratio of lactam B to catalyst is in the range from 1:1 to 100 000:1.

10. The process for crosslinking polyamide according to claim 1 wherein the molar ratio of lactam A to catalyst is in the range from 0.01:1 to 100:1.
